(19) United States
(12) Patent Application Publication
(10) Pub. No.: US 2023/0348790 A1
(43) Pub. Date: Nov. 2, 2023

(54) COMBINED GASIFICATION AND STEAM METHANE REFORMATION SYSTEMS AND METHODS

(71) Applicants: Agra Energy, Irvine, CA (US); DVO Licensing, Inc., Chilton, WI (US)

(72) Inventors: Steve Dvorak, Chilton, WI (US); Andrew Lucero, Irvine, CA (US); Anthony Long, Irvine, CA (US)

(73) Assignees: Agra Energy, Irvine, CA (US); DVO Licensing, Inc., Chilton, WI (US)

(21) Appl. No.: 18/308,258

(22) Filed: Apr. 27, 2023

Related U.S. Application Data
(60) Provisional application No. 63/363,762, filed on Apr. 28, 2022.

(51) Int. Cl. C10G 2/00; C10J 3/72; C01B 3/34

(52) U.S. Cl. CPC C10G 2/32; C10J 3/72; C01B 3/34; C10J 2300/0916; C01B 2203/0216; C01B 2203/1241; C01B 2203/062; C10J 2300/1659; C10G 2300/1018; C10G 2300/20; C10G 2300/42; C10G 2300/4025

(57) ABSTRACT

Exemplary systems, processes, and methods for combining synthesis gas flows from more than one source or reactor, for example, gasification and biogas steam methane reformation, are provided. The exemplary systems, processes, and methods may be used to generate liquid fuels from farm waste.

### CROSS REFERENCE TO RELATED APPLICATIONS

This application claims priority of U.S. Provisional Application No. 63/363,762, filed Apr. 28, 2022 and entitled “Combined Gasification and Steam Methane Reformation Systems and Methods,” which is hereby incorporated in its entirety by reference.

### BACKGROUND

The GTL (gas to liquids) process is a refinery or conversion process to convert natural gas or other gaseous hydrocarbons into longer-chain hydrocarbons, such as gasoline or diesel fuel. The Fischer-Tropsch process is a GTL polymerization technique that turns a carbon source into hydrocarbons chains through the hydrogenation of carbon monoxide by means of a metal catalyst. The carbon source can be converted to synthesis gas (syngas).

What is needed is a system and process to combine synthesis gas flows from more than one source or reactor, for example gasification and steam methane reformation.

### BRIEF DESCRIPTION OF DRAWINGS

The foregoing summary and the following detailed description are better understood when read in conjunction with the appended drawings. Example embodiments are shown in the drawings; however, it is understood that the embodiments are not limited to the specific structures depicted herein. In the drawings:

FIG. 1 is a flow diagram illustrating a combined gasification and biogas steam methane reformation system, according to an exemplary embodiment of the present disclosure.

### DETAILED DESCRIPTION

The terminology used in the present disclosure is for the purpose of describing particular example embodiments only and is not intended to be limiting. As used in the description of the embodiments of the disclosure and the appended claims, the singular forms “a,” “an,” and “the” are intended to include the plural forms as well, unless the context clearly indicates otherwise.

The term “and/or,” as used herein, refers to and encompasses any and all possible combinations of one or more of the associated listed items.

The term “about,” as used herein when referring to a measurable value such as an amount of a component, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this disclosure belongs.

The present disclosure provides processes, systems, and methods of combining synthesis gas flows from more than one source or reactor. In an embodiment, the present disclosure provides combined gasification and steam methane reformation systems, methods and processes. In an embodiment, processes and systems of combining the resulting synthesis gas flows from more than one, for example two, independent sources or reactors are provided. The present disclosure can provide processes for conversion of the synthesis gases via Fischer Tropsch to hydrocarbon products. In an embodiment, a first reactor may create synthesis gas through steam methane reformation using a biogas source and steam as inputs. In an embodiment, a second reactor can be a gasification reactor that can use bio-solids materials to create a synthesis gas.

The present disclosure provides methods, processes, and systems for combining more than one synthesis gas streams to produce a synthesis gas feed stream for Fischer Tropsch reaction at an ideal ratio for the production of larger hydrocarbons. In an embodiment, the combination of the synthesis gas streams, for example two streams, can be used to balance the ratio of the hydrogen content to the carbon monoxide content of the synthesis gas stream. Synthesis gas from a gasification reaction can be significantly lacking in hydrogen for proper Fischer Tropsch reaction chemistry. Synthesis gas streams from steam methane reformation may be significantly rich in hydrogen content. In an embodiment, the present disclosure provides processes, methods, and systems for controlling the hydrogen content in the steam methane reformation output, which can allow for a balancing of the ratio of the combined gas stream to meet ideal or desired Fischer Tropsch chemistry conditions.

The systems and methods of the present disclosure can be applied in large and/or small-scale farm operations and can be used to alleviate farm wastes and reduce fossil fuel usage.

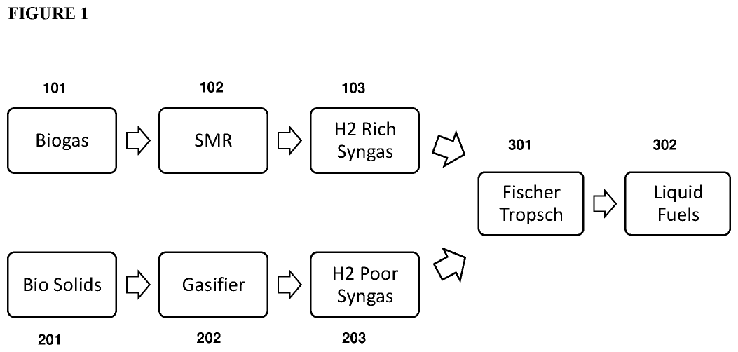

FIG. 1 is a flow diagram illustrating a combined gasification and biogas steam methane reformation system, according to an exemplary embodiment of the present disclosure. The process of converting biogas via steam methane reformation (SMR) can produce hydrogen rich synthesis gas (syngas). The process of converting bio solids via gasification can produce hydrogen poor syngas. The hydrogen rich syngas and hydrogen poor syngas can be combined in varying ratios to obtain ideal or desired Fischer Tropsch chemistry conditions. The resulting combination of hydrogen rich syngas and hydrogen poor syngas can be converted to liquid fuel via Fischer Tropsch. The different processes described below are generally performed by the corresponding components of the system.

FIG. 1 shows an exemplary combined gasification and biogas steam methane reformation system, according to an embodiment of the present disclosure. Biogas (101) can undergo a steam methane reformation (SMR) process (102), e.g., performed in a SMR reactor, to produce hydrogen (H₂) rich synthesis gas (syngas) (103). Bio solids (201) can undergo a gasification process, e.g., via a gasifier (202), to produce hydrogen (H₂) poor syngas (203). The hydrogen rich syngas (103) can be combined with the hydrogen poor syngas (203) in varying ratios. For example, in an embodiment, the syngas combination can comprise about 10%, about 20%, about 30%, about 40%, about 50%, about 60%, about 70%, about 80%, or about 90% hydrogen rich syngas (103). In an embodiment, the syngas combination can be about 10%, about 20%, about 30%, about 40%, about 50%, about 60%, about 70%, about 80%, or about 90% hydrogen poor syngas (203). The combination of hydrogen rich syngas (103) and hydrogen poor syngas (203) can undergo a Fischer Tropsch process (301), e.g., performed in a Fischer Tropsch reactor, to produce liquid fuel (302).

In an embodiment, the methods, processes, and systems of the present disclosure can involve development of digester systems that can be matched with the Micro-GTL units for processing of their biogas. In an embodiment, the system of the present disclosure can comprise an anaerobic digester, a pyrolysis unit, and/or a Micro-GTL unit. In an embodiment, the system of the present disclosure can comprise a gas line adjustment to Micro-GTL inlet, H₂S scrubbing from the biogas stream, residual heat use for input to digester, electrical connection for Micro-GTL system, foundation for Micro-GTL unit, weather shelter for majority of Micro-GTL unit, collection tank for runoff that can be pumped to digester, storage tanks for products, truck access to storage tanks, and/or permitting.

In an embodiment, the methods, processes, and systems can be used on a farm setting. For example, the biogas (101) can be generated from an anaerobic digestion of organic waste generated in a farm. Bio solids (201) may include solid organic matter (e.g., cow dung) that may be collected in the farm, e.g., through farm sewage processing.

While the present disclosure has been discussed in terms of certain embodiments, it should be appreciated that the present disclosure is not so limited. The embodiments are explained herein by way of example, and there are numerous modifications, variations and other embodiments that may be employed that would still be within the scope of the present disclosure.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. The examples set forth in this document are for illustrative purposes and all elements of the example may not be required or exhaustive. Accordingly, other implementations are within the scope of the following claims. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter. For example, the steps and/or limitations in the specification, drawings, and/or claims may be performed in an order other than the order set forth in the specification, drawings, and/or claims.

In addition, it should be understood that any figures which highlight the functionality and advantages are presented for example purposes only. The disclosed methodology and system are each sufficiently flexible and configurable such that they may be utilized in ways other than that shown. For example, other steps may be provided, or steps may be eliminated, from the described flows, and other components may be added to, or removed from, the described systems.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
combining more than one synthesis gas streams to produce a resulting synthesis gas feed stream for Fischer Tropsch reaction.

2. The method of claim 1, wherein the more than one synthesis gas streams comprise a synthesis gas stream from a gasification reaction and a synthesis gas stream from a steam methane reformation.

3. The method of claim 2, wherein the synthesis gas stream from the gasification reaction comprises a lower hydrogen content than the synthesis gas stream from the steam methane reformation.

4. The method of claim 2, wherein the synthesis gas stream from the steam methane reformation comprises a higher hydrogen content than the synthesis gas stream from the gasification reaction.

5. The method of claim 1, wherein the resulting synthesis gas stream comprises an ideal or desired ratio of hydrogen to carbon monoxide for use in the Fischer Tropsch reaction.

6. A system comprising:
a first source generating a first synthesis gas stream;
a second source generating a second synthesis gas stream; and
a Fischer Tropsch reactor receiving a combination the first synthesis gas stream and the second synthesis gas stream and generating a liquid fuel.

7. The system of claim 6, the first source comprising a steam methane reforming reactor.

8. The system of claim 7, the steam methane reforming reactor generating the first synthesis gas stream from biogas.

9. The system of claim 6, the second source comprising a gasifier.

10. The system of claim 9, the gasifier generating the second synthesis gas stream from bio solids.

11. The system of claim 6, the first synthesis gas stream being generated from biogas.

12. The system of claim 6, the second synthesis gas stream being generated from bio solids.

13. The system of claim 6, the first synthesis gas stream comprising a higher hydrogen content than the second synthesis gas stream.

14. The system of claim 6, the first synthesis gas stream comprising a lower hydrogen content than the second synthesis gas stream.

15. The system of claim 6, a Fischer Tropsch reactor receiving the combination of the first synthesis gas stream and the second synthesis gas stream in an ideal or desired ratio of hydrogen to carbon monoxide for use in a Fischer Tropsch reaction.

16. A method of generating liquid fuel from farm waste, the method comprising:
generating a first synthesis gas stream from a first type of farm waste;
generating a second synthesis gas stream from a second type of farm waste;
combining the first synthesis gas stream and the second synthesis gas stream to generate a synthesis gas feed stream for a Fischer Tropsch reaction to generate the liquid fuel.

17. The method of claim 16, the first type of farm waste comprising biogas, and the step of generating the first synthesis gas stream comprising:
using a steam methane reformation process on the biogas to generate the first synthesis gas stream.

18. The method of claim 17, further comprising:
anaerobically digesting organic matter to generate the biogas.

19. The method of claim 16, the second type of farm waste comprising bio solids, and the step of generating the second synthesis gas stream comprising:
gasifying the bio solids to generate the second synthesis gas stream.

20. The method of claim 19, further comprising:
processing farm sewage to extract solid organic matter as the bio solids.
